(19) United States
(12) Patent Application Publication
(10) Pub. No.: US 2025/0031023 A1
(43) Pub. Date: Jan. 23, 2025

(54) METHOD, SYSTEM AND DEVICE FOR AUTONOMOUSLY IDENTIFYING AN EMERGENCY

(71) Applicant: Unify Patente GmbH & Co KG, Munich (DE)

(72) Inventors: Georgios Christidis, Alimos (GR); Mikes Chronopoulos, Nea Smyrni (GR); Alexandros Piliafas, Agios Dimitrios (GR); Sotirios Tsapikounis, Nea Smyrni (GR)

(21) Appl. No.: 18/768,253

(22) Filed: Jul. 10, 2024

(30) Foreign Application Priority Data
Jul. 21, 2023 (EP) 23187082.5

(51) Int. Cl. H04W 4/90

(52) U.S. Cl. CPC H04W 4/90

(57) ABSTRACT

A method, a system and a device for autonomously identifying an emergency can be configured so that sensor data from at least one sensor of a first device can be monitored; an abnormality in the sensor data of the at least one sensor can be detected; and the abnormality state can be initiated and the abnormal sensor data from the at least one sensor can be stored. A message comprising the abnormal sensor data can be generated for broadcasting to further devices over all types of available networks that are connectable to the first device.

### CROSS-REFERENCE TO RELATED APPLICATIONS

The present application claims priority to European Patent Application No. EP 23187082.5, filed on Jul. 21, 2023. The entirety of European Patent Application No. EP 23187082.5 is incorporated by reference herein.

### FIELD

The present invention relates to a method of nearby devices autonomously identifying and validating an emergency situation and automatically calling emergency services, a system which is adapted to perform said method and at least one device which can perform the inventive method.

### BACKGROUND

Systems for emergency related communications can be appreciated from U.S. Pat. Nos. 11,627,222, 11,706,091, 11,800,344, 11,805,399, 11,843,397, 11,956,287, 11,956,706, and 12,015,738. These systems can be configured to receive an emergency call and collected data from a user of a communication device utilized to make the emergency call related to the emergency for use in responding to the emergency situation.

### SUMMARY

We determined that a problem can arise when an emergency occurs in an area where there is no central authority to report it. Currently, systems can be configured so that a communication device activates an automatic emergency contact protocol using a mobile station. Therefore, the location information is automatically determined and tracked. An emergency notification server stores the data associated with the event and generates an automated emergency call.

Moreover, computer-implemented methods for generating an automated response to a catastrophic event that includes data generated and received from home sensors are often configured to determine whether the data indicates a match to the threshold pattern and automatically generating a response if there is a match to the threshold pattern.

In some situations, a non-transitory computer-readable media can determine a geographical area associated with a crisis.

However, we determined that these types of methods and systems depend on a central system, or a computer-controlled database that stores and controls the emergency information and acts upon emergency identification. We have therefore developed embodiments of a process, system, and apparatus can be configured so that devices can communicate directly with each other and can act autonomously to call emergency services, if affected by a certain disaster.

For example, embodiments of a method for autonomously identifying an emergency is provided that can include the steps of:
monitoring, by an application of a first device, sensor data from at least one sensor of or connected to the first device,
detecting or receiving, by the application of the first device, an abnormality in the sensor data of the at least one sensor,
initiating abnormality state and storing, by the application of the first device, the abnormal sensor data from the at least one sensor,
generating, by the application of the first device, a message comprising the abnormal sensor data, and
broadcasting, by the application of the first device, the generated message to all further devices over all types of available networks.

In the field of information technology (IT), the term “application” typically refers to a software program or computer program that is designed to perform specific tasks or functions to meet the needs of the present claimed invention. An application, also known as a software application or simply an “app,” is a set of instructions or code written by software developers that is executed by a computer to perform a specific function or provide a specific service. Code of the app can be stored in non-transitory memory or other type of non-transitory computer readable medium. A processor of a device can execute the code so the device can perform a process defined by the code. When an application performs monitoring, detecting, initiating, generating, and/or broadcasting, the device that runs the application can perform these functions via running the code of the application.

The present used application run by a device can enable sensor data to be processed in accordance with embodiments of the present method. This application may be installed in whole or in part on a device or stored on a server or in a cloud that can be accessed via a device for running the code to perform the processing defined by the code of the application.

In case the application of the first device detects or receives an abnormality in sensor data of at least one sensor, the application of the first device can initiate an event (e.g. the device running the app can initiate the event).

For the purposes of the invention, at least one sensor means a sensor that can be installed inside the first device (internal sensor) or outside of it (external sensor). However, an external sensor is at least partially connected to the first device in order to transmit sensor data to it using known transmission techniques.

In other words, when a sensor of a device detects an abrupt change in the state of environmental attribute(s), an abnormality state is initiated, and an application on this device initiates an event by sending a message to report the abnormality state such that a message is generated by the device running the app and the device sends such a message. Thus, an event is a message. This event sets the device into an emergency state, and a message which contains the state of the device, the type of the alarm event and the time it is generated.

This generated message is being broadcasted by each device to any of the nearby connected devices over all available types of networks.

According to a preferred embodiment, the method further comprises the step of checking, by the application of the first device, all available types of networks. Networks by means of the present invention relate to all types of communication networks. Communication networks refer to the infrastructure and systems that enable the exchange of information and data between multiple devices, systems, or users. Communication networks can be physical or virtual, wired or wireless, and can vary in size, complexity, and scope, ranging from local area networks (LANs) to global wide area networks (WANs). Communication networks are the backbone of modern information and communication technology (ICT) systems, enabling seamless communication, data transfer, and collaboration among devices, systems, and users.

The physical or virtual connections that allow data to be transmitted between nodes in the network, can be wired, such as Ethernet cables or fiber optic cables, or wireless, such as Wi-Fi or cellular connections. Cellular connection, such as 5G, refers to a wireless communication technology that enables devices to connect to the internet and other devices via cellular networks. Cellular networks consist of a series of interconnected cells, each served by a base station or cell tower, which provide wireless coverage to a specific area. Devices, such as smartphones, tablets, Internet of Things (IoT) devices, and other mobile devices, communicate with these base stations to establish a cellular connection and access the internet and other services.

All smart devices located in the same vicinity communicate via established methods over any available type of physical or virtual connection. The devices are connected in a mesh network and can detect abnormalities. Each smart device can be a type of computer device that includes at least one processor connected to non-transitory memory and at least one transceiver unit (e.g. Bluetooth transceiver, Wi-Fi transceiver, etc.). Examples of smart devices can include smart watches, cellular phones, smart phones, tablets, digital personal assistant device, or other type of smart communication device.

Each smart device can exchange appropriately constructed messages with other devices over an established and available network. For example, the smart devices in a building are connected to an already established wireless mesh network (WMN) and can detect abnormalities via built-in sensors. In case, a connection type, e.g. Wi-Fi, is not available, the devices will still exchange messages via the rest of the available networks, e.g. via Bluetooth (BT) or a cellular network.

In case a communication network is not available, the broadcasting mechanism uses other available networks. The area in which this message is being broadcasted is defined by the range capabilities of each available communication protocol and the coverage it can offer under any circumstances. This way, it is ensured that only nearby devices will act accordingly during an emergency situation in a specific area.

According to another preferred embodiment, the network is a communication network, in particular, the communication network is one or more of a Wireless mesh network (WMN), a Wi-Fi network, a Bluetooth network, a cellular network, a data network, a telecommunications network, local area networks (LAN), and Wide Area Network (WAN).

In particular, the cellular network is a broadband cellular network such as a 4G network, a 5G network, and/or a 6G network.

According to yet another preferred embodiment, the method further comprises the steps of:
receiving a message, by the application of the first device, comprising abnormal sensor data of at least one sensor of a second or any further device,
validating, by the application of the first device, the abnormal sensor data of the first device, with the abnormal sensor data of the received message, and
automatically initiating, by the application of the first device, a call to an emergency service, in case of a match of the validated data.

As noted above, the device running the application can perform the receipt of the message, the validating, and the automatic initiating via running the application. Therefore, the devices such as the first device can generate and receive messages about abnormal sensor data from the nearby devices reachable over all available networks.

In case the device receives a message from one of a nearby device connected to the same network, a validation of the message contents takes place to check if the abnormality “state”, “alarm” and “time” reported by the other devices match the data of the state of the device itself. If there is a match, the abnormality state is confirmed for each connected device, the broadcasting stops, and the device has now realized that an emergency situation has occurred in the vicinity and proceeds with calling emergency services.

Emergency services are a collection of specialized services that are responsible for responding to urgent situations that pose an immediate threat to life, health, property, or the environment. Examples for emergency services are Emergency Medical Services (EMS), Fire and Rescue, Law Enforcement (e.g. police departments), Search and Rescue, and Emergency Management.

In addition to this automatic call, the user of the first device can also receive an alert, informing the user that an emergency service is being called automatically and the reason why. The alert can be generated for display and/or output to the user via the user's smart device (e.g. display of the smart device, speaker of the smart device, other output device of the smart device that can be communicatively connected to the processor and/or non-transitory memory of the device, etc.). The smart device can also include one or more input devices (e.g. the display can be a touch screen display communicatively connected to the processor and non-transitory memory, the device can include one or more buttons, a pointer device, a keyboard or keypad, a microphone, etc.).

According to still another preferred embodiment, the present method further comprises the steps of:
initiating, by the application of the first device, an alarm to the first device, in case of no match of the validated data,
automatically initiating, by the application of the first device, a call to an emergency service, in case the alarm is not deactivated by the user of the first device.

The device running the application can perform the initiating and the automatic initiating of the call to the emergency service via running the application.

As a fallback mechanism, if no other nearby devices are connected while the device is broadcasting the message, and after a pre-defined period of not receiving any message from other devices, the user of the device will be notified with a device alarm or message, waiting for the user to confirm or deny the emergency. If the user interacts with the alarm and rejects the message, the device assumes that there is no emergency affecting that user. If there is no confirmation or rejection from the user, the device proceeds to call emergency services.

The pre-defined period of not receiving messages from other devices can be in a range between 10 seconds and 5 minutes, preferably in a range between 30 seconds and 2 minutes, and more preferably in 60 seconds.

An alarm of the device can refer to a feature or function that allows the device to emit a sound, a vibration, or a visual notification at a pre-determined time or under specific conditions. It is typically used to alert the user or draw their attention to a particular event, such as notifying them of an incoming message or call. The alarm can be deactivated by any interaction of the user with the first device. Such an alert can be output by one or more output devices that can be communicatively connected to the device's processor and/or non-transitory memory, for example.

Further, according to a preferred embodiment, the method further comprises the steps of returning, by the application of the first device, the first device into an initial idle state, in case the alarm is deactivated by the user of the first device. The initial idle state of a smart device can refer to the state of the device when neither an abnormality in the sensor data has been detected nor a message has been received comprising abnormal sensor data of at least one sensor of a second or any further device so that the application of the device is not actively being used or performing any specific tasks.

According to yet another preferred embodiment, the first, the second, and any further device is a smart device (e.g. smart phone, smart watch, smart personal assistant device, etc.). A smart device, also known as a connected or Internet of Things (IoT) device, can refer to a device that is capable of connecting to the Internet or other devices and has built-in intelligence, computing power, and communication capabilities. Smart devices can be standalone devices or part of a larger network of interconnected devices, and they can be designed to enhance and simplify various aspects of everyday life by offering advanced features, automation, and connectivity. At least one sensor is built into the smart device.

Examples of smart devices include smartphones, smartwatches, smart speakers, smart thermostats, smart lights, smart TVs, smart appliances such as refrigerators, ovens, washing machines, and vacuum cleaners which are connected to the Internet and can be controlled or monitored remotely, smart security systems, smart transportation, such as cars, bikes, aircrafts, ships, trains, and smart health and fitness devices, such as fitness trackers or smart scales, among others.

Further, IoT sensors can be installed in buildings, machinery, transport mediums like aircrafts, ships, trains, etc., monitor several environmental attributes like altitude, humidity, temperature, and/or pressure. Sensors can also detect chemical or gas leakage, smoke as well as abrupt changes in level when accelerometer, gyroscope and motion sensors are used.

These are just some examples of the many types of smart devices that are available today. As technology continues to advance, the list of smart devices is likely to expand, offering new and innovative ways to improve convenience, efficiency, and connectivity in various aspects of our daily lives.

According to another preferred embodiment, the stored abnormal sensor data comprises a flag indicating the state of the first device regarding the abnormal sensor data, a type of the alarm with regard to an environmental attribute, and a time at which the abnormal sensor data was generated.

These abnormal sensor data are stored by the application of the first device. Further the application of the first device generates a message comprising these abnormal sensor data. Further, the application of the first device may receive a message from a second or any further device also comprising these abnormal sensor data.

In more detail, the generated message of the first, the second or any further device as well as the stored abnormal sensor data can include
a. the state of the device: State Abnormality (SA): “state”=true/false,
b. the type of alarm that caused the event: “alarm”=gas/temperature/altitude, etc.,
c. the time the alarm was generated: “time”=hh: mm: ss.

In some embodiments, the generated messages can include other data or have a different configuration or format.

In the context of IT, the term “flag” refers to a binary or Boolean value used to indicate a certain condition or state in a computer program or system. Flags are typically used as variables or data elements that hold a single value, typically either “true” or “false”, to represent a specific condition or state. The state of the device indicates whether there is a state abnormality or not, e.g. whether if the state is “true” or “false”.

The type of alarm indicates the reason why an abnormality is present. For example, the type may be any environmental attribute which can be detected via sensors of smart devices, such as gas, temperature, or smoke.

The time indicates when the alarm was generated.

According to a preferred embodiment, the application of the first device detects amendments of environmental attributes using a sensor of the first device, wherein the environmental attribute is one or more of altitude, humidity, temperature, pressure, chemicals, gas, smoke, level, accelerometer, gyroscope, and motion.

Abnormality in sensor data refers to readings or measurements obtained from a sensor that deviate significantly from the expected or normal values. In the context of a sensor that detects altitude, humidity, temperature, pressure, chemicals, gas, smoke, level, accelerometer, gyroscope, and motion in the sensor data could manifest in various ways depending on the type of sensor and the environmental conditions in which it is deployed.

Thus, an abnormality in the sensor data from, e.g. humidity sensors, or temperature sensors, by means of the present invention result in readings that are significantly higher or lower than the expected humidity range or temperature range for a given environment.

An abnormality in the sensor data from an altitude sensor by means of the present invention can be due to changes in environmental conditions such as changes in atmospheric pressure or temperature.

An abnormality in the sensor data from a humidity sensor by means of the present invention can be due to changes in environmental conditions such as moisture sources or ventilation.

An abnormality in the sensor data from a temperature sensor by means of the present invention can be due to external factors such as heat sources or environmental changes.

An abnormality in the sensor data from a pressure sensor by means of the present invention can be due to changes in environmental conditions such as altitude or weather patterns.

Abnormalities in the sensor data from chemical and gas sensors by means of the present invention result in readings that indicate unexpected levels of chemical or gas concentrations in the environment. This can be due to changes in environmental conditions.

An abnormality in the sensor data from a smoke sensor by means of the present invention leads to false positive or false negative results in detecting the presence or absence of smoke in the environment.

An abnormality in the sensor data from a level sensor by means of the present invention results in readings that do not accurately represent the actual level of a liquid or solid substance being measured. This can be due to changes in the physical properties of the substance being measured.

Abnormalities in the sensor data from accelerometers and gyroscopes by means of the present invention result in readings that do not accurately represent the actual motion or orientation of an object. This could be due to abrupt height changes, e.g. a person falling to the ground.

Detecting abnormality in sensor data is an important task in sensor-based systems as it can help identify potential issues or anomalies in the sensor measurements. Techniques such as statistical analysis, data filtering, data fusion, and machine learning algorithms can be used to detect abnormality in sensor data and take appropriate actions based on the specific requirements of the application or system in which the sensors are deployed.

According to a yet another preferred embodiment, the validation step comprises comparing, by the application of the first device, the stored abnormal sensor data of the first device with the received abnormal sensor data from the message of a second or any further device, and/or wherein the compared abnormal sensor data comprise the state of the device, the type of alarm related to an environmental attribute, and the time at which the abnormal sensor data was generated.

In the present application, validation is the process of verifying or confirming the data within the message generated by the first device against the data within the message received by the second or any further device.

With regard to the state of the device, a match is present if the flags indicating the state of the first and a second or any further device are the same, e.g. both flags indicate either “true” or “false”.

Further, a match is present if the types of alarm related to an environmental attribute of the first and the second device are the same, e.g. both types relate to the same environmental attribute, for example temperature.

Moreover, a match is present if the times at which the abnormal sensor data were generated by the first and the second device are within a pre-defined time frame.

According to a preferred embodiment, the time frame is less than 60 seconds, preferably less than 30 seconds, more preferably less than 10 seconds.

For the validation to be successful, all three compared data must match.

As soon as one of the three data does not match, the validation is not successful.

According to a preferred embodiment, in case the validation matches, each connected device confirms the broadcasting stop.

Moreover, each of the first, second and/or further devices acts as a standalone entity which autonomously identifies, validates, and reports the emergency. Thus, each smart device located in a specific area acts as a standalone entity that detects an abnormality and communicates directly with other nearby smart devices and each one decides and acts upon emergency.

Embodiments of a device is provided which is configured to perform the above-described method for autonomously identifying an emergency. For example, the device can have a processor that is communicatively connected to a non-transitory computer readable medium having the application stored thereon for running the code of the application to perform one or more tasks defined by the code of the application. In some embodiments, the application can be accessible via local memory having the application stored thereon and/or access to the application via a cloud based or internet based communicative connection with a server device that may host services associated with running of the application.

According to yet another aspect of the present invention, a system for autonomously identifying an emergency is provided, wherein the system comprises at least two devices according to the above-mentioned aspects of the present invention. Embodiments of the system may also include other elements (e.g. a server, an access point, a base station, etc.).

According to yet another aspect of the present invention, a program element is disclosed that can be stored on a non-transitory computer readable medium so that when the element is executed by a processor, a device of the processor is adapted to carry out steps defined by code of the program element. Such steps can be steps of an embodiment of the above-described method, for example.

It has also to be noted that aspects of the invention have been described with reference to different subject-matters. In particular, some aspects or embodiments have been described with reference to apparatus type claims whereas other aspects have been described with reference to method type claims. However, a person skilled in the art will gather from the above and the following description that, unless otherwise notified, in addition to any combination between features belonging to one type of subject-matter also any combination between features relating to different types of subject-matters is considered to be disclosed with this text. In particular, combinations between features relating to the apparatus type claims and features relating to the method type claims are considered to be disclosed.

Other details, objects, and advantages of the telecommunications apparatus, system, device, non-transitory computer readable medium, and method will become apparent as the following description of certain exemplary embodiments thereof proceeds.

### BRIEF DESCRIPTION OF THE DRAWINGS

The invention and embodiments thereof will be described below in further detail in connection with the drawing(s).

FIG. 1 shows a flowchart of the method for autonomously identifying an emergency in a specific area and calling an emergency service according to an embodiment of the invention.

FIG. 2 shows a schematic illustration of two smart devices receiving the same alarm from built-in sensors according to another embodiment of the invention.

FIG. 3 shows a schematic illustration of three smart devices receiving alarms from a different IoT-sensor according to another embodiment of the invention.

FIG. 4 shows a schematic illustration of three smart devices receiving different or no alarms from a different IoT-sensor according to another embodiment of the invention.

Reference numerals used in the drawings include:

| | |
|---|---|
| BT | Bluetooth |
| D1, D2, etc. | first device, second device, etc. |
| D1SA1, etc. | state abnormality of first device, etc. |
| temp | temperature |
| S101-S600 | method steps S101-S600 |

### DETAILED DESCRIPTION

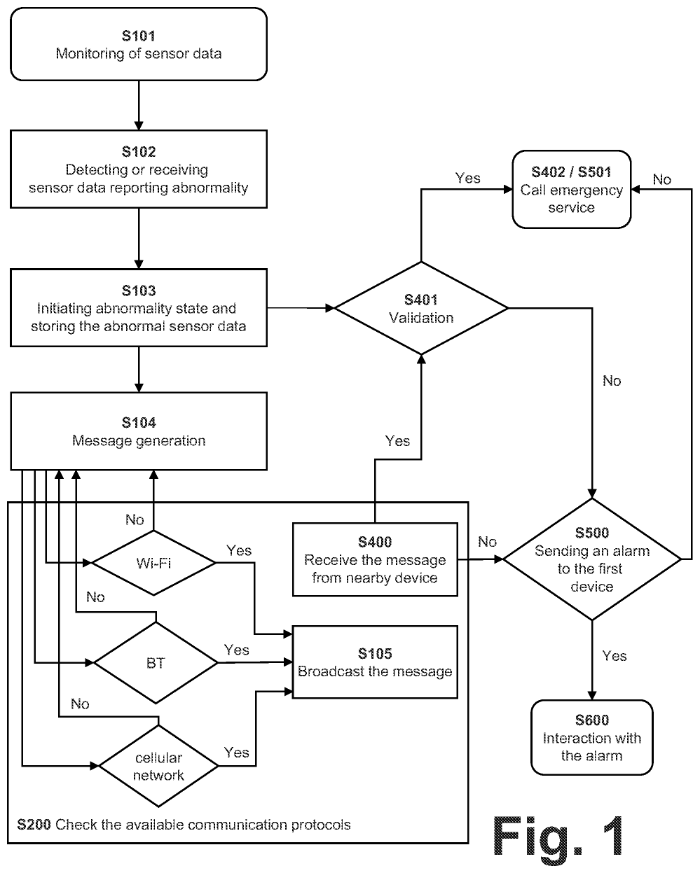

FIG. 1 shows a flowchart of an exemplary embodiment of the method for autonomously identifying an emergency in a specific area and calling an emergency service.

First, built-in sensors of IoT devices, for example, in a building as well as built-in sensors of smart devices like smartphones and smartwatches are monitoring changes in the environment and other parameters (S101).

Second, a sensor detects an abrupt change in the state of the environmental attribute, or the smart device receives input from nearby IoT sensors for an abrupt change of an environmental attribute (S102). For example, during an earthquake, a high-rise building located in a non-urban isolated area collapses. Several people working in this building become affected. The smart device sensors installed in the building detect a sudden change of motion and altitude via its built-in gyroscope and accelerometer or, in another case, the smart device such as a smartphone of an individual receives input from nearby IoT sensors regarding a change in motion and altitude. In the first case, the smartwatches and smartphones people are using detect this sudden orientation and motion change and classify it as a fall of an individual via already existing implemented software. Depending on the device, the software can either be part of the operating system or be installed as an application on the device.

A software running on the smart device initiates an event by sending a message to report the abnormality state and stores the data (S103). For example, the software installed and running on the IoT sensors platform assures that the information collected by the sensors is transmitted to the smart devices, e.g. smartwatches and smartphones, via Wi-Fi or Bluetooth (BT). In addition, a specific software runs on the smart device and collects the data from the IoT sensors (temperature increase), or the data generated by the smart device itself when the device detected the sudden fall.

Said data is stored to be later used by the validation mechanism (S401). For example, assuming a smart device has detected a fall as soon as sensor data is collected, the software initiates an event and brings the device into a state of abnormality. At this state, the data describing the event is stored to be later used by the validation mechanism.

In a next step, when the device is in the abnormality state, the software of the device generates a message (S104) which includes the state of the device, whether it is in an abnormality state or not, the type of event, e.g. in this case an altitude alarm was triggered, and the time of the occurrence.

The generated message contains, for example:
a. the state of the device: State Abnormality (SA): “state”=true,
b. the type of alarm that caused the event: “alarm”=altitude,
c. the time of the alarm: “time”=13:28:52.

As soon as the message is generated, the software checks, if the device is connected to a Wi-Fi network to which other smart devices are also connected (S200). If yes, then it broadcasts the generated event that contains the abnormality state message to any of the devices connected to the same Wi-Fi network (S105). In case a Wi-Fi connection is not available, or in addition to the first available network such as Wi-Fi the software checks, if BT is available and if a connection to other devices exists (S200). If yes, then it broadcasts the generated event that contains the abnormality state message to any of the devices connected via BT (S105).

Furthermore, the software also checks if a cellular network, for example a 5G network, is enabled (S200), and, if yes, it broadcasts the same message to the other smart devices via device-to-device (D2D) communication capability of cellular networks (S105). The purpose of this mechanism is that every connected device broadcasts the abnormality state message to all nearby devices. If a device is located outside the area of emergency, but still receives the abnormality message via, for example 5G, from affected devices, it will not confirm the emergency because no alarm has been received by this device. This way, the method ensures that only nearby devices will act accordingly during an emergency in a specific area.

According to the present example, all nearby smart devices are connected in the same cell tower antenna, since they are all located in the same building, creating a local network of smart devices. Smart devices which lack cell connectivity capabilities connect to the other devices via BT or Wi-Fi. The software that runs on the smart devices makes sure that the devices remain connected with each other via BT or connected to the Wi-Fi network.

Since every device executes a broadcast at the same time, every device also receives a message (S400) containing the abnormality state data from other nearby interconnected devices that broadcasted. Steps S105 and S400 run in parallel because when a device transmits, it may also receive transmissions initiated by nearby devices.

When such a message is received, the software running on the device executes the validation mechanism (S401). This mechanism validates the data included in an incoming message against the data already stored in the device itself when the abnormality state event was initiated and the data to be used for validation was stored in step S103.

If the validation mechanism reports that there is a match between the data stored in the device (state, type of event, time frame) and the data received from the nearby devices, this means that the abnormality state is confirmed. Each device realizes that there are also other nearby devices affected as the same time by the same incident. This indicates that there is a true emergency in this area and the smart device automatically initiates a call to emergency services (S402).

As a fallback mechanism, in case the validation mechanism (S401) does not result in a match between the device's own state (S103) and the event state received by the nearby devices (S400), the device informs the user of the device about its own abnormality state via well-known and already established device notification methods, e.g. an alarm notification which requires user interaction (S500).

If the user interacts with the notification, e.g. by dismissing the alarm, then the person admits that there is no danger, the alarm is ignored, and the device goes back to its initial idle state (S600). In case, there is no human interaction to the alarm notification in a short, pre-defined time frame, then this means that the person is not capable of interacting with the device, and therefore an emergency is assumed, and the smart device automatically calls emergency services (S501).

In a similar context to the previous example, the same method is applied in different real-life scenarios. In a hydrogen production plant, an explosion occurs, setting the factory to an uncontrolled fire. The IoT sensors installed in the factory detect the sudden change in temperature as well as the smoke caused by the fire. The smartwatches and smartphones people are using detect this sudden temperature change. Software installed and running on the IoT sensors' platform transmits the information collected by the sensors to the smart devices, e.g. smartwatches and smartphones via Wi-Fi or BT. Specific software running on the smart devices collects the data from the IoT sensors as well as the data generated by the smart devices itself when the devices detected the sudden temperature change. The rest of the flow is like in the previous example; the devices initiate an event and go into a state of abnormality where a message is generated and broadcasted to all connected nearby devices. Received messages are validated on each device, and in case the received abnormality state from nearby devices matches the device's own abnormality state then the emergency situation is confirmed, and the device automatically calls emergency services.

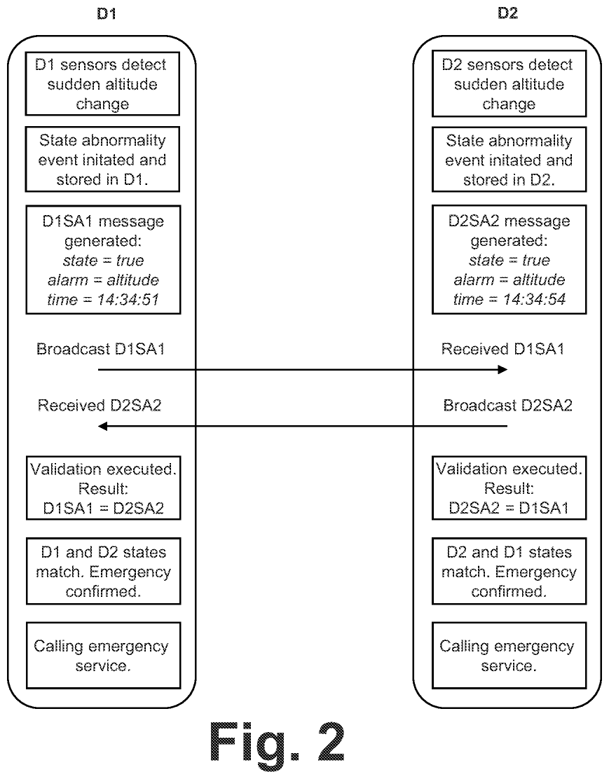

FIG. 2 schematically shows a scenario, where two smart devices receive the same alarm from built-in sensors. In this scenario, smart devices D1 and D2 are, for example, in the same building which collapsed.

First, the built-in gyroscope, accelerometer and barometer sensors detect a sudden change in altitude in D1 and D2. This alarm is received by the smart devices, and an abnormality state is initiated and stored in D1 (D1SA1) and D2 (D2SA2).

In the next step, the appropriate message is generated in both devices:

```
  D1SA1 message:
  state = true
  alarm = altitude
  time = 14:34:51
  D2SA2 message:
  state = true
  alarm = altitude
  time = 14:34:54
state = true means the device has entered an abnormality state,
alarm = altitude means the device has received an alarm regarding
an altitude change,
and
time = 14:34:51 shows the time at which the alarm was generated.
```

Via an available communication protocol (Wi-Fi, Bluetooth or 5G (D2D)),
D1 broadcasts the D1SA1 message to device D2,
D2 broadcasts the D2SA2 message to device D1, and
D1 receives the message from D2,
D2 receives the message from D1.

The received D2SA2 message enters the D1 validator, and the received D1SA1 message enters the D2 validator.

### Validator D1:

The validator compares the D2SA2 message with the D1SA1 stored in D1.
State=true for both messages, D1SA1 and D2SA2 match;
alarm=altitude for both messages, D1SA1 and D2SA2 match;
time=is validated as the messages are in the same pre-defined time frame, e.g. if
the time difference is less than 10 s, D1SA1 and D2SA2 match.
The validation result in D1 is that D1SA1 and D2SA2 match.
The emergency is confirmed on D1.
D1 calls an emergency service.

### Validator D2:

The validator compares the D1SA1 message with the D2SA2 stored in D2.
State=true for both messages, D1SA1 and D2SA2 match;
alarm=altitude for both messages, D1SA1 and D2SA2 match;
time=is validated as the messages are in the same pre-defined time frame, e.g. the
time difference is less than 10 s, D1SA1 and D2SA2 match.
The validation result in D2 is that D2SA2 and D1SA1 match.
The emergency is confirmed on D2.
D2 calls an emergency service.

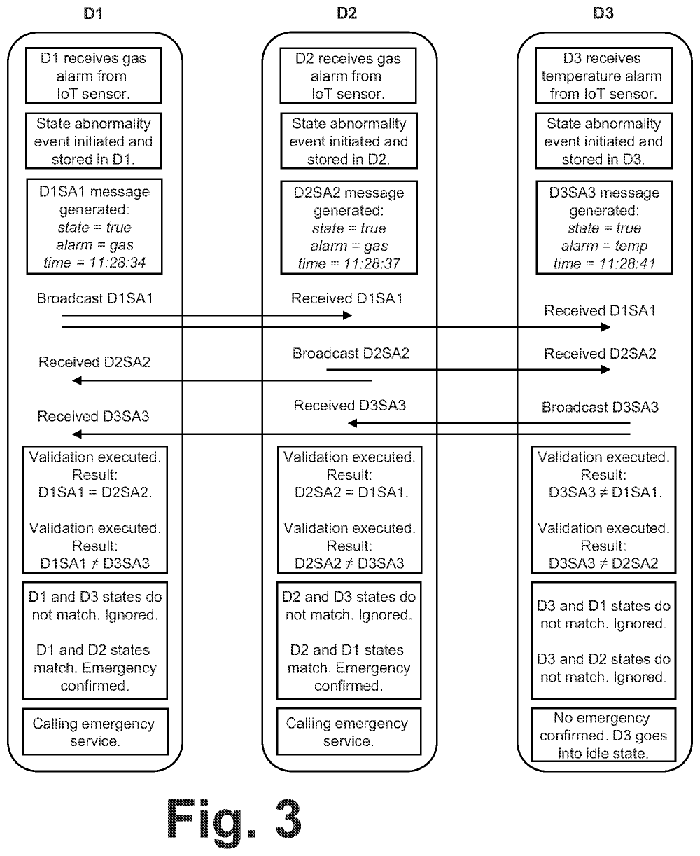

FIG. 3 schematically shows a scenario, where two smart devices receive a gas alarm from IoT sensors, and a further device receives a temperature alarm from a different IoT sensor. In this scenario, D1, D2 and D3 are smart devices located in the same building but D3 is on a different floor. D1 and D2 receive a gas leak alarm from the nearby IoT sensors but D3 receives a high-temperature alarm from another IoT sensor.

An abnormality state is initiated and stored in D1 (D1SA1), D2 (D2SA2) and D3 (D3SA3). The appropriate message is generated in all three devices:

D1SA1 message:
state = true
alarm = gas
time = 11:28:34
D2SA2 message:
state = true
alarm = gas
time = 11:28:37
D3SA3 message:
state = true
alarm = temp
time = 11:28:41
state = true means the device has entered an abnormality state,
alarm = gas means the device has received an alarm regarding a gas leak,
alarm = temp means the device has received an alarm regarding a temperature
change (for example, an increase), and
time = 11:28:34, shows the time at which the alarm was generated.

Via an available communication protocol (Wi-Fi, Bluetooth or 5G (D2D)),
D1 broadcasts the D1SA1 message to devices D2 and D3.
D2 broadcasts the D2SA2 message to devices D1 and D3.
D3 broadcasts the D3SA3 message to devices D2 and D1.
D1 receives the messages from D2 and D3.
D2 receives the messages from D1 and D3.
D3 receives the messages from D2 and D1.

The received D2SA2 and D3SA3 messages enter the D1 validator, the received D1SA1 and D3SA3 messages enter the D2 validator, and the received D2SA2 and D1SA1 messages enter the D3 validator.

### Validator D1:

The validator compares the D2SA2 message with the D1SA1 stored in D1.
State=true for both messages, D1SA1 and D2SA2 match;
alarm=gas for both messages, D1SA1 and D2SA2 match;
time=is validated as the messages are in the same pre-defined time frame, e.g. the
time difference is less than 10 s, D1SA1 and D2SA2 match.
The validation result in D1 is that D1SA1 and D2SA2 match.

The validator compares the D3SA3 message with the D1SA1 stored in D1.
State=true for both messages, D1SA1 and D3SA3 match;
alarm=gas for D1SA1 #temp for D3SA3, D1SA1 and D3SA3 do not match;
time=is validated as the messages are in the same pre-defined time frame, e.g. the
time difference is less than 10 s, D1SA1 and D3SA3 match.
The validation result in D1 is that D1SA1 and D3SA3 do not match.
At least one result from the validator is a match.
The emergency is confirmed on D1.
D1 calls an emergency service.

### Validator D2:

The validator compares the D1SA1 message with the D2SA2 stored in D2.
State=true for both messages, D2SA2 and D1SA1 match;
alarm=gas for both messages, D2SA2 and D1SA1 match;
time=is validated as the messages are in the same pre-defined time frame, e.g. the
time difference is less than 10 s, D1SA1 and D2SA2 match.
The validation result in D2 is that D2SA2 and D1SA1 match.

The validator compares the D3SA3 message with the D2SA2 stored in D2.
State=true for both messages, D2SA2 and D3SA3 match;
alarm=gas for D2SA2 #temp for D3SA3, D2SA2 and D3SA3 do not match;
time=is validated as the messages are in the same pre-defined time frame, e.g. the
time difference is less than 10 s, D2SA2 and D3SA3 match.

The validation result in D2 is that D2SA2 and D3SA3 do not match.
At least one result from the validator is a match.
The emergency is confirmed on D2.
D2 calls an emergency service.

### Validator D3:

The validator compares the D1SA1 message with the D3SA3 stored in D3.
State=true for both messages, D3SA3 and D1SA1 match;
alarm=gas for D1SA1 #temp for D3SA3 D1SA1 and D3SA3 do not match;
time=is validated as the messages are in the same pre-defined time frame, e.g. the
time difference is less than 10 s, D3SA3 and D1SA1 match.
The validation result in D3 is that D3SA3 and D1SA1 do not match.

The validator compares the D2SA2 message with the D3SA3 stored in D3.
State=true for both messages, D2SA2 and D3SA3 match.
Alarm=gas for D2SA2 #temp for D3SA3 D2SA2 and D3SA3 do not match;
time=is validated as the messages are in the same pre-defined time frame, e.g. the time difference is less than 10 s, D2SA2 and D3SA3 match.
The validation result in D3 is that D3SA3 and D2SA2 do not match.
The validation results in no matches.
The emergency is not confirmed on D3.
D3 does not call an emergency service.
D3 returns to the idle state.

It could have been the case, that a further device D4 located on the same floor as D3 could have received the same temperature alarm as D3 did. Therefore, there could have been a positive validation between D3 and D4 resulting in D3 and D4 calling an emergency service.

This embodiment shows a successful (D1 against D2) as well as a not successful validation (D1/D2 against D3) result.

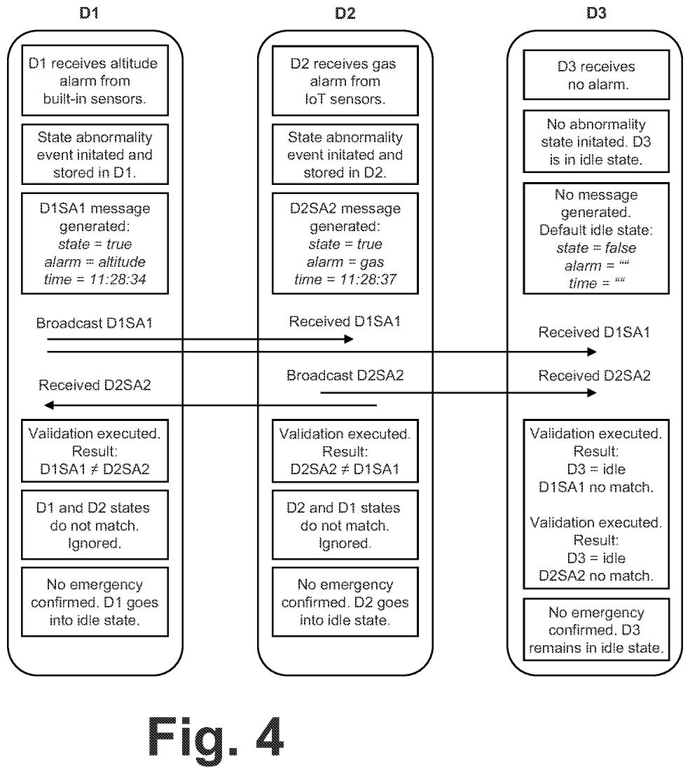

FIG. 4 schematically shows a scenario, where three smart devices receive different or no alarm via built-in or IoT sensors. In this exemplary scenario, smart device D1 detects a sudden change of altitude (e.g. a possible fall) from the input of the built-in accelerometer, gyroscope and barometer and receives an altitude alarm from the built-in sensors. Smart device D2 detects a sudden change of gas and receives a gas alarm from an IoT sensor. Smart device D3 detects no change of the environmental attribute so that D3 receives no alarm either from built-in or IoT sensors.

Therefore, an abnormality state is initiated and stored in D1 (D1SA1) and D2 (D2SA2). D3 does not go into an abnormality state.

The appropriate message is generated in D1 and D2. D3 holds the default message stored for idle state.

```
  D1SA1 message:
  state = true
  alarm = altitude
  time = 11:28:34
  D2SA2 message:
  state = true
  alarm = gas
  time = 11:28:37
  D3 default idle state message:
  state = false
  alarm = “”
  time = “”
state = true means the device has entered an abnormality state;
state = false means the device has not entered an abnormality state;
alarm = altitude means the device has received an alarm regarding
an altitude change;
alarm = gas means the device has received an alarm regarding a gas leak;
alarm = “” means no alarm is received by the device;
time = 11:28:34 shows the time at which the alarm was generated;
time = “” indicates no time value as no alarm was generated.
```

Via an available communication protocol (Wi-Fi, Bluetooth or 5G (D2D)),
D1 broadcasts the D1SA1 message to devices D2 and D3.
D2 broadcasts the D2SA2 message to devices D1 and D3.
D3 does not broadcast any message to devices D2 and D1.
D1 receives the message from D2.
D2 receives the message from D1.
D3 receives the messages from D2 and D1.

The received D2SA2 message enters the D1 validator.

The received D1SA1 message enters the D2 validator.

The received D2SA2 and D1SA1 messages enter the D3 validator.

### Validator D1:

The validator compares the D2SA2 message with the D1SA1 stored in D1.
State=true for both messages, D1SA1 and D2SA2 match;
alarm=altitude for D1SA1 #gas for D2SA2, D1SA1 and D2SA2 do not match;
time=is validated as the messages are in the same pre-defined time frame, e.g. the
time difference is less than 10 s, D1SA1 and D2SA2 match.
The validation result in D1 is that D1SA1 and D2SA2 do not match.
The validation results in no match.
The emergency is not confirmed on D1.
D1 does not call an emergency service.
D1 returns to the idle state.

### Validator D2:

The validator compares the D1SA1 message with the D2SA2 stored in D2.
State=true for both messages, D2SA2 and D1SA1 match;
alarm=gas for D2SA2 #altitude for D1SA1, D2SA2 and D1SA1 do not match;
time=is validated as the messages are in the same pre-defined time frame, e.g. the
time difference is less than 10 s, D2SA2 and D1SA1 match.
The validation result in D2 is that D2SA2 and D1SA1 do not match.
The validation results in no match.
The emergency is not confirmed on D2.
D2 does not call an emergency service.
D2 returns to the idle state.

### Validator D3:

The validator compares the D1SA1 message with the default one stored in D3.
State=false for D3 #true for D1SA1, D1SA1 and D3 do not match;
As soon as the “state” value is not matched, the validator provides a no match result.
The validation result in D3 is that D3 state and D1SA1 do not match.

The validator compares the D2SA2 message with the default one stored in D3.
State=false for D3 #true for D2SA2, D1SA1 and D3 do not match;
As soon as “the state” value is not matched, the validator provides a no match result.
The validation result in D3 is that D3 state and D2SA2 do not match.
The validation results in no match.
The emergency is not confirmed on D3.
D3 does not call an emergency service.
D3 remains in the idle state.

It could have been the case, that other nearby devices would have received the same alarms as D1 or D2. Therefore, there could have been a positive validation between these devices and D1 or D2, resulting in D1 or D2 calling an emergency service.

As discussed above, it should be appreciated that a device running software can perform the function that the software performs. The software can configure the device that runs the software to be configured to perform different steps of a process or method defined by code of the software that is run by a processor of the device, for example.

The first, the second, and any further device can be a smart device (e.g. smart phone, smart watch, smart personal assistant device, etc.). A smart device, also known as a connected or Internet of Things (IoT) device, can refer to a device that is capable of connecting to the Internet or other devices and has built-in intelligence, computing power, and communication capabilities. Smart devices can be standalone devices or part of a larger network of interconnected devices, and they can be designed to enhance and simplify various aspects of everyday life by offering advanced features, automation, and connectivity. At least one sensor is built into the smart device. These devices can include a processor connected to a non-transitory memory and at least one transceiver unit. Each device can also include at least one input device and/or at least one output device (e.g. a microphone, a speaker, a touch screen display, a button, a keypad, a keyboard, a pointer device, a display, etc.) communicatively connectable to the processor and/or non-transitory memory.

Examples of smart devices that can be utilized in embodiments of the method or apparatus can include smartphones, smartwatches, smart speakers, smart thermostats, smart lights, smart TVs, smart appliances such as refrigerators, ovens, washing machines, and vacuum cleaners which are connected to the Internet and can be controlled or monitored remotely, smart security systems, smart transportation, such as cars, bikes, aircrafts, ships, trains, and smart health and fitness devices, such as fitness trackers or smart scales, among others.

It should be noted that the term “comprising” does not exclude other elements or steps and the “a” or “an” does not exclude a plurality. Further, elements described in association with different embodiments may be combined.

It should also be noted that reference signs in the claims shall not be construed as limiting the scope of the claims.

It should therefore be appreciated that different embodiments of the method, communication system, communication apparatus, and non-transitory computer readable medium can be developed to meet different sets of design criteria. For example, the particular type of network connection, server configuration or client configuration for a device for use in embodiments of the method can be adapted to account for different sets of design criteria. As yet another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a telecommunication apparatus, telecommunication device, computer device, a network, a server, a communication system, and methods of making and using the same have been shown and described above, it is to be distinctly understood that the invention is not limited thereto but may be otherwise variously embodied and practiced within the scope of the following claims.

What is claimed is:

1. A method for autonomously identifying an emergency, wherein the method comprising the steps of:
monitoring, by a first device, sensor data from at least one sensor of or connected to the first device,
detecting or receiving, by the first device, an abnormality in the sensor data of the at least one sensor,
initiating an abnormality state and storing, by the first device, the sensor data from the at least one sensor having the abnormality,
generating, by the first device, a message comprising the abnormal sensor data, and
broadcasting, by the first device, the generated message to all further devices over all types of available networks communicatively connectable to the first device.

2. The method of claim 1, wherein the first device has a processor connected to a non-transitory computer readable medium having an application stored thereon, the application having code that is runnable by the processor.

3. The method of claim 1, also comprising:
checking, by the first device, all available types of networks to which the first device is communicatively connectable for broadcasting of the generated message.

4. The method of claim 1, wherein the available networks include at least one communication network.

5. The method of claim 4, wherein the at least one communication network is a Wireless mesh network (WMN), a Wi-Fi network, a Bluetooth network, a cellular network, a data network, a telecommunications network, a local area network (LAN), and/or a Wide Area Network (WAN).

6. The method of claim 1, comprising:
the first device receiving a message comprising abnormal sensor data of at least one sensor of a second device;
the first device validating the sensor data from the at least one sensor having the abnormality of the first device with the abnormal sensor data of the received message, and
the first device automatically initiating a call to an emergency service in response to a match of the validated data.

7. The method of claim 1, further comprising:
initiating, by the first device, an alarm to the first device, in case of no match of the validated data,
automatically initiating, by the first device, a call to an emergency service in response to the alarm not being deactivated by a user of the first device.

8. The method of claim 7, also comprising:
returning, the first device into an initial idle state in response to the alarm being deactivated by the user of the first device.

9. The method of claim 1 wherein the first device is a smart device.

10. The method of claim 1, wherein the sensor data from the at least one sensor having the abnormality comprises:
a flag indicating the state of the first device regarding the abnormal sensor data,
a type of the alarm with regard to an environmental attribute, and/or
a time at which the abnormal sensor data was generated.

11. The method of claim 1, wherein the first device detects amendments of one or more environmental attributes using the at least one sensor of the first device, wherein the one or more environmental attributes is one or more of altitude, humidity, temperature, pressure, chemicals, gas, smoke, level, accelerometer, gyroscope, and motion.

12. The method of claim 1, also comprising:
the first device receiving a message comprising abnormal sensor data of at least one sensor of a second device;
the first device validating the sensor data from the at least one sensor having the abnormality of the first device with the abnormal sensor data of the received message, the validating including:
comparing, by the first device, the stored sensor data from the at least one sensor having the abnormality of the first device with the received abnormal sensor data from the message of the second device; and
the first device automatically initiating a call to an emergency service in response to a match of the validated data.

13. The method of claim 12, wherein the abnormal sensor data comprises a state of the second device, a type of alarm related to an environmental attribute, and/or a time at which the abnormal sensor data was generated.

14. The method of claim 12, wherein a time frame is less than 60 seconds for the abnormal sensor data.

15. The method of claim 12, wherein in case the validation matches, each connected device confirms a broadcasting stop.

16. A device having a processor connected to a non-transitory memory having code of an application stored thereon, the processor configured to run the code such that the device performs a method when the processor runs the code, the method comprising:
monitoring, by the device, sensor data from at least one sensor of or connected to the device,
detecting or receiving, by the device, an abnormality in the sensor data of the at least one sensor,
initiating an abnormality state and storing, by the device, the sensor data from the at least one sensor having the abnormality,
generating, by the device, a message comprising the abnormal sensor data, and
broadcasting, by the device, the generated message to all further devices over all types of available networks communicatively connectable to the device.

17. A system for autonomously identifying an emergency, wherein system comprises a plurality of devices, the plurality of devices including a first device and a second device communicatively connectable to the first device, each of the devices having a processor connected to a non-transitory memory having code of an application stored thereon, the processor configured to run the code such that the device performs a method when the processor runs the code, the method comprising:
monitoring, by the device, sensor data from at least one sensor of or connected to the device,
detecting or receiving, by the device, an abnormality in the sensor data of the at least one sensor,
initiating an abnormality state and storing, by the device, the sensor data from the at least one sensor having the abnormality,
generating, by the device, a message comprising the abnormal sensor data, and
broadcasting, by the device, the generated message to all further devices over all types of available networks communicatively connectable to the first device.
